(19) United States
(12) Patent Application Publication
(10) Pub. No.: US 2025/0230351 A1
(43) Pub. Date: Jul. 17, 2025

(54) COMPOSITIONS COMPRISING TETRAFLUOROPROPENE AND HEXAFLUOROBUTENE

(71) Applicant: THE CHEMOURS COMPANY FC, LLC, WILMINGTON, DE (US)

(72) Inventors: SHENG PENG, HOCKESSIN, DE (US); BARBARA HAVILAND MINOR, THE VILLAGES, FL (US); JIAN SUN-BLANKS, ARAB, AL (US); MARY E. KOBAN, CHADDS FORD, PA (US)

(73) Assignee: THE CHEMOURS COMPANY FC, LLC, WILMINGTON, DE (US)

(21) Appl. No.: 18/855,733

(22) PCT Filed: Apr. 21, 2023
(86) PCT No.: PCT/US2023/019329

§ 371 Date: Oct. 10, 2024

Related U.S. Application Data
(60) Provisional application No. 63/333,825, filed on Apr. 22, 2022.

(51) Int. Cl. C09K 5/04

(52) U.S. Cl. CPC C09K 5/045; C09K 2205/122; C09K 2205/22

(57) ABSTRACT

Disclosed are compositions comprising tetrafluoropropene (HFO-1234yf and/or HFO-1234ze) and hexafluorobutene. Such compositions are useful, among other uses, as heat transfer compositions for use in refrigeration, air-conditioning and heat pump systems.

### CROSS REFERENCE TO RELATED APPLICATIONS

This application is a national filing under 35 U.S. C. 371 of International Application No. PCT/US2023/019329 filed Apr. 12, 2023, and claims the benefit of priority of U.S. Provisional Application No. 63/333,825, filed Apr. 22, 2022, which are incorporated by reference herein in their entirety.

### FIELD

The present invention relates to compositions comprising tetrafluoropropene and hexafluorobutene.

### BACKGROUND

New environmental regulations on refrigerants have forced the refrigeration and air-conditioning industry to look for new refrigerants with low global warming potential (GWP).

Replacement refrigerants are being sought that have low GWP, low toxicity, low or no flammability, reasonable cost and excellent refrigeration performance. Fluoroolefins provide satisfy these criteria. In addition, desired properties in a refrigerant include ease of detecting leaks, performance including efficiency and capacity refrigerant applications, solubility in lubricants used in such applications and compatibility with components used in such applications.

Tetrafluoropropenes (1234yf and 1234ze) and fluorobutenes are examples of fluoroolefins having a low Global Warming Potential (GWP) and are alternatives to high GWP hydrofluorocarbons and/or ozone-depleting hydrochlorofluorocarbons in numerous applications such as refrigeration, air-conditioning, heating and cooling, power cycles. Improvement in properties of compositions comprising tetrafluoropropenes is desired.

### SUMMARY

The present disclosure provides a fluoroolefin composition comprising a tetrafluoropropene and a hexafluorobutene. The tetrafluoropropene is 2,3,3,3-tetrafluoropropene or E-1,3,3,3-tetrafluoropropene or a combination of 2,3,3,3-tetrafluoropropene and E-1,3,3,3-tetrafluoropropene. The hexafluorobutene is E-1,1,1,4,4,4-hexafluoro-2-butene or Z-1,1,1,4,4,4-hexafluoro-2-butene or a combination of E-1,1,1,4,4,4-hexafluoro-2-butene and Z-1,1,1,4,4,4-hexafluoro-2-butene.

In one embodiment, the tetrafluoropropene is 2,3,3,3-tetrafluoropropene. In another embodiment, the tetrafluoropropene is E-1,3,3,3-tetrafluoropropene (trans isomer). In another embodiment, the tetrafluoropropene is a combination of 2,3,3,3-tetrafluoropropene and E-1,3,3,3-tetrafluoropropene.

In one embodiment, the hexafluorobutene is E-1,1,1,4,4,4-hexafluorobutene (trans isomer). In another embodiment, the hexafluorobutene is Z-1,1,1,4,4,4-hexafluorobutene (cis isomer). In another embodiment, the hexafluorobutene is a combination of both of E-1,1,1,4,4,4-hexafluoro-2-butene and Z-1,1,1,4,4,4-hexafluoro-2-butene.

The fluoroolefin compositions disclosed herein may be useful as heat transfer compositions, aerosol propellants, foaming agents, blowing agents, solvents, cleaning agents, carrier fluids, displacement drying agents, buffing abrasion agents, polymerization media, expansion agents for polyolefins and polyurethane, gaseous dielectrics, extinguishing agents, and fire suppression agents in liquid or gaseous form.

In particular, the fluoroolefin compositions disclosed herein are useful in applications as heat transfer compositions. Heat transfer compositions may further comprise a lubricant such as polyol ester (POE), polyalkylene glycol (PAG), polyvinyl ether (PVE) and synthetic hydrocarbon oils. The compositions disclosed herein may improve performance of heat transfer compositions with lubricant in such applications.

### DESCRIPTION

### Compositions

The present disclosure provides a fluoroolefin composition comprising a tetrafluoropropene and a hexafluorobutene, wherein the tetrafluoropropene is tetrafluoropropene is 2,3,3,3-tetrafluoropropene or E-1,3,3,3-tetrafluoropropene or a combination of 2,3,3,3-tetrafluoropropene and E-1,3,3,3-tetrafluoropropene and the hexafluorobutene is E-1,1,1,4,4,4-hexafluoro-2-butene or Z-1,1,1,4,4,4-hexafluoro-2-butene or a combination of E-1,1,1,4,4,4-hexafluoro-2-butene and Z-1,1,1,4,4,4-hexafluoro-2-butene.

The tetrafluoropropene, 2,3,3,3-tetrafluoropropene, may also be referred to herein as 1234yf. The tetrafluoropropene, E-1,3,3,3-tetrafluoropropene, may also be referred to herein as E1234ze, which is the trans isomer.

The hexafluorobutene, E-1,1,1,4,4,4-hexafluoro-2-butene, may also be referred to herein as E1336mzz, which is the trans isomer. The hexafluorobutene, Z-1,1,1,4,4,4-hexafluoro-2-butene, may also be referred to herein as Z1336mzz, which is the cis isomer.

In one embodiment, the tetrafluoropropene is 2,3,3,3-tetrafluoropropene. In another embodiment, the tetrafluoropropene is E-1,3,3,3-tetrafluoropropene (trans isomer). In another embodiment, the tetrafluoropropene is a combination of 2,3,3,3-tetrafluoropropene and E-1,3,3,3-tetrafluoropropene.

In one embodiment, the hexafluorobutene is E-1,1,1,4,4,4-hexafluorobutene (trans isomer). In another embodiment, the hexafluorobutene is Z-1,1,1,4,4,4-hexafluorobutene (cis isomer). In another embodiment, the hexafluorobutene is a combination of both of E-1,1,1,4,4,4-hexafluoro-2-butene and Z-1,1,1,4,4,4-hexafluoro-2-butene.

The fluoroolefin composition comprises at least 50 wt % of tetrafluoropropene and hexafluorobutene, or at least 70 wt % of tetrafluoropropene and hexafluorobutene, or at least 90 wt % of tetrafluoropropene and hexafluorobutene, each wt % based on the total weight of the fluoroolefin composition.

In one embodiment, the tetrafluoropropene and hexafluorobutene comprise from 90 wt % up to 100 wt % of the fluoroolefin composition. In another embodiment, the tetrafluoropropene and hexafluorobutene comprise from 95.00 wt % to 99.99 wt % of the composition. In another embodiment, the tetrafluoropropene and hexafluorobutene comprise from 98.0 wt % to 99.8 wt % of the composition.

### Tetrafluoropropene

The tetrafluoropropene component of the composition is 2,3,3,3-tetrafluoropropene (1234yf) or E-1,3,3,3-tetrafluoropropene (E1234ze). These compounds are commercially available or can be manufactured by various known processes.

The tetrafluoropropene has a purity (concentration of 1234yf or E1234ze relative to other components of the tetrafluoropropene component of the fluoroolefin composition) of at least 99.95 wt % or at least 99.9 wt % or at least 99.8 wt % or at least 99.5 wt % or at least 99 wt %.

In one embodiment, the tetrafluoropropene is 1234yf.

In one embodiment, the tetrafluoropropene is E1234ze.

In one embodiment, the tetrafluoropropene is a combination of 1234yf and E1234ze. When the tetrafluoropropene is a combination of 1234yf and E1234ze, the amount of each component may vary from 0.01 wt % to 99.99 wt % or from 0.1 wt % to 99.9 wt % or from 0.5 wt % to 99.5 wt %.

### Hexafluorobutene

The hexafluorobutene component of the composition is 1,1,1,4,4,4-hexafluoro-2-butene as the Z-(cis) or E-(trans) isomer, Z1336mzz or E1336mzz, respectively. These compounds are commercially available or can be manufactured by various known processes.

The hexafluorobutene has a purity (concentration of Z- or E1336mzz relative to other components of the hexafluorobutene component of the fluoroolefin composition) of at least 99.95 wt % or at least 99.9 wt % or at least 99.8 wt % or at least 99.5 wt % or at least 99 wt %.

In one embodiment, the hexafluorobutene is Z1336mzz

In one embodiment, the hexafluorobutene is E1336mzz.

In one embodiment, the hexafluorobutene is a combination of Z1336mzz and E1336mzz. When the hexafluorobutene is a combination of Z1336mzz and E1336mzz, the amount of each component may vary from 0.001 wt % to 99.99 wt % or from 0.005 wt % to 99.9 wt % or from 0.01 wt % to 99.5 wt %.

### Additional Compounds

The fluorobutene composition disclosed herein may further comprise one or more additional compounds.

The additional compound may be chosen from one or more of HFC-32 (difluoromethane), HFC-125 (pentafluoroethane), HFC-134 (1,1,2,2-tetrafluoroethane), HFC-134a (1,1,1,2-tetrafluoroethane), HFC-152a (1,1-difluoroethane), HFC-161 (ethyl fluoride), HFC-227ea (1,1,1,2,2,3,3,3-heptafluoropropane), HFC-236fa (1,1,1,3,3,3-hexafluoropropane), HFO-1233zd (1-chloro-3,3,3-trifluoropropene), HFO-1224 yd (1-chloro-2,3,3,3-tetrafluoropropene) and CO2.

The additional compound may be chosen from one or more of CC-40 (chloromethane), CFC-12 (dichlorodifluoromethane), HFC-23 (trifluoromethane), HCFC-124 (1-chloro-1,2,2,2-tetrafluoroelhane), HCFC-124a (1-chloro-1,1,2,2-tetrafluoroethane), HCFC-142b (1-chloro-1,1-difluoroethane), HFC-143a (1,1,1-trifluoroethane), HFC-244bb (2-chloro-1,1,1,2-tetrafluoropropane), HFC-245cb (1,1,1,2,2-pentafluoropropane), HFC-245fa (1,1,1,3,3-pentafluoropropane), HFC-254eb (1,1,1,2-tetrafluoropropane), HFC-263fb (1,1,1-trifluoropropane), HFO-1123 (1,1,2-trifluoroethylene), HFO-1243zf (3,3,3-trifluoropropene), HFO-1225ye (E- or Z-1,2,3,3,3-pentafluoropropene), HFO-1225zc (1,1,3,3,3-pentafluoropropene), 3,3,3-trifluoro-1-propyne, HCFO-1233xf (2-chloro-3,3,3-trifluoropropene), HCFO-1122 (2-chloro-1,1-difluoroethylene), HFO-1132 (E- and/or Z-1,2-difluoroethylene), HCFO-1132a (1,1-difluoroethylene), HCO-1140 (vinyl chloride), HCFO-1131 (E- and/or Z-1-chloro-2-fluoroethylene), and HCFO-1131a (1-chloro-1-fluoroethylene).

The additional compounds containing halogens are recited in Table 1.

The additional compound may be chosen to provide improvement in refrigerant performance or other benefit such as improving compatibility with additives, such as lubricants. An improvement in refrigerant performance may include higher capacity or better efficiency.

TABLE 1
Compound Names and Formulae

| Compound | Chemical formula | Chemical name |
|---|---|---|
| CFC-12 | CCl₂F₂ | dichlorodifluoromethane |
| HFC-23 | CHF₃ | trifluoromethane |
| HFC-32 | CH₂F₂ | difluoromethane |
| CC-40 | CH₃Cl | chloromethane |
| HCFC-124 | CHClFCF₃ | 1-chloro-1,2,2,2-tetrafluoroethane |
| HCFC-124a | CClF2CHClF2 | 1-chloro-1,1,2,2-tetrafluoroethane |
| HFC-125 | CF₃CHF₂ | pentafluoroethane |
| HFC-134 | CHF₂CHF₂ | 1,1,2,2-tetrafluoroethane |
| HFC-134a | CF₃CH₂F | 1,1,1,2-tetrafluoroethane |
| HCFC-142b | CClF₂CH₃ | 1-chloro-1, 1-difluoroethane |
| HFC-143a | CF₃CH₃ | 1,1,1-trifluoroethane |
| HFC-152a | CHF₂CH₃ | 1,1-difluoroethane |
| HFC-161 | CH₃CH₂F | ethyl fluoride |
| HCFO-1122 | CF₂═CHCl | 2-chloro-1, 1-difluoroethylene |
| HFO-1123 | CF₂═CHF | 1,1,2-trifluoroethylene |
| HCFO-1131 | CHCl═CHF | E- and/or Z-1-chloro-2-fluoroethylene |
| HCFO-1131a | CClF═CH₂ | 1-chloro-1-fluoroethylene |
| HFO-1132 | CHF═CHF | E- and/or Z-1,2-difluoroethylene |
| HFO-1132a | CF₂═CH₂ | 1,1-difluoroethylene |
| HCO-1140 | CH₂═CHCl | vinyl chloride |
| HFC-227ea | CF₃CF₂CHF₂ | 1,1,1,2,2,3,3,3-heptafluoropropane |
| HFC-236fa | CF₃CH₂CF₃ | 1,1,1,3,3,3-hexafluoropropane |
| HFC-244bb | CF₃CFClCH₃ | 2-chloro-1,1,1,2-tetrafluoropropane |
| HFC-245cb | CF₃CF₂CH₃ | 1,1,1,2,2-pentafluoropropane |
| HFC-245fa | CF₃CH₂CHF₂ | 1,1,1,3,3-pentafluoropropane |
| HFC-254eb | CF₃CHFCH₃ | 1,1,1,2-tetrafluoropropane |
| CFC-12 | CCl₂F₂ | dichlorodifluoromethane |
| HFC-23 | CHF₃ | trifluoromethane |
| HFC-32 | CH₂F₂ | difluoromethane |
| HFC-263fb | CF₃CH₂CH₃ | 1,1,1-trifluoropropane |
| HCFO-1233xf | CF₃CCl═CH₂ | 2-chloro-3,3,3-trifluoropropene |
| HFO-1233zd | E- and/or Z-CF₃CH═CHCl | 1-chloro-3,3,3-trifluoropropene |
| HFO-1224yd | E- and/or Z-CF₃CF═CHCl | 1-chloro-2,3,3,3-tetrafluoropropene |
| HFO-1225ye | E- and/or Z-CF₃CF═CHF | E- or Z-1,2,3,3,3-pentafluoropropene |
| HFO-1225zc | CF₃CH═CF₂ | 1, 1,3,3,3-pentafluoropropene |
| HFO-1243zf | CF₃CH═CH₂ | 3,3,3-trifluoropropene |
| | CH≡CCF₃ | 3,3,3-trifluoro-1-propyne |

It is desired that the additional compound maintains the composition's global warming potential (GWP) less than 1500 or less than 750 or less than 150. The additional compound may lower the GWP of the composition to less than 4, which is the GWP of 1234yf or less than 1, which is the GWP of E1234ze. For example, certain hydrofluoroolefins (HFOs) have a GWP of less than 4, such as HFO-1243zf, which has a GWP of less than 1.

In one embodiment of the present disclosure, the additional compound may be chosen from one or more of HFO-1243zf, HFC-134a, HCFO-1122, HFC-254eb, HCFC-124 and HFC-23. In one embodiment, the additional compound is a combination of HFO-1243zf, HFC-134a and HFC-143a. In one embodiment, the additional compound is a combination of HFO-1243zf, HFC-134a, HFC-143a, HCFO-1122 and HFC-254eb.

In one embodiment, the tetrafluoropropene is a combination of 1234yf and E1234ze and further comprises an additional compound chosen from one or more of HFC-152a, HCFO-1131a, HCO-1140, CFC-12, HFC-244bb and HCFO-1233xf.

In one embodiment, when the tetrafluoropropene is a combination of 1234yf and E1234ze, the additional compound is HFC-152a. In one embodiment, when the tetrafluoropropene is a combination of 1234yf and E1234ze, the additional compound is a combination of HFC-152a, HCFO-1131a, HCO-1140, HFC-244bb and HCFO-1233xf.

In one embodiment of the present disclosure, the additional compound may be chosen from one or more of Z-HFO-1225ye, HC-40, E-HFO-1132 and HFC-263fb. In one embodiment, the additional compound is a combination of Z-HFO-1225ye, E-HFO-1132 and HFC-263fb.

In one embodiment, the additional compound is a minor component of the composition. In such an embodiment, the amount of an additional compound may be greater than 0 wt % and less than 1 wt %. The total amount of additional compounds present may be greater than 0.1 ppm and less than 0.5 wt % of the total weight of the composition. The total amount of additional compounds present may be greater than 1 ppm and less than 0.1 wt % of the total weight of the composition. The total amount of additional compounds present may be greater than 10 ppm or greater than 100 ppm or greater than 1000 ppm. The total amount of additional compounds may be less than 1 wt % or less than 0.5 wt % or less than 0.1 wt %. In one embodiment, the amount of additional compounds is less than 1 wt %, such that the amount of 1234yf is at least 99%, or the amount of additional compounds is less than 0.5%, such that the amount of 1234yf is at least 99.5%.

### Inhibitor

The composition may further comprise an inhibitor. The inhibitor may be a hydrocarbon comprising at least one of cyclic monoterpene; lipophilic organic compounds including tocopherols such as a-tocopherol; phenols, aromatic organic compounds having at least one chemical moiety C6H4 (OH) including benzene-1,4-diol, to fluoroolefin containing refrigerant compositions will increase the stability thereof during packaging, storage and usage in refrigeration or air-conditioning system applications. Specific examples of inhibitor compounds may be chosen from limonene, a-terpinene, pinene (alpha, beta), a-tocopherol, butylated hydroxytoluene, 4-methoxyphenol, benzene-1,4-diol. In one embodiment, the inhibitor comprises a-terpinene.

In one embodiment, the composition comprises limonene or a-terpinene optionally with an anti-oxidant having a unique fragrance even at a few ppm level. This pleasant odor can be utilized for leakage detection of the composition, for example, in heat transfer applications. This is especially beneficial for early refrigerant leakage detection in household air conditioner or mobile air conditioner as paraprofessional electronic leak detectors often are not available in either location.

While any suitable amount of inhibitor may be employed, effective amounts comprise from 0.001 wt % to 10 wt %, 0.01 wt % to 5 wt %, 0.3 wt % to 4 wt %, 0.3 wt % to 1 wt % based on the total weight of the composition. In one embodiment, an effective amount comprises 10 to 2000 ppm or 10 to 1000 ppm or 10 to 500 ppm of at least one inhibitor.

### Anti-Oxidant

One embodiment of the invention relates to a composition as disclosed herein further comprising at least one anti-oxidant. While any suitable oxidant can be employed, examples of suitable oxidants comprise at least one member selected from the group consisting of butylated hydroxytoluene, butylated hydroxyanisole, tertiary-butylhydroquinone, gallate, 2-phenyl-2-propanol, 1-(2,4,5-trihydroxyphenyl)-1-butanone, bisphenol methane derivatives, 2,2′-methylene bis(4-methyl-6-t-butyl phenol), among other phenolics, and combinations thereof.

### Preparation of the Composition

The components of the compositions disclosed herein may be prepared by any means known in the art or procured from commercial suppliers and/or specialty chemical producers.

If needed, the tetrafluoropropene and/or hexafluorobutene may be subject to purification steps in preparing the compositions disclosed herein. To achieve a purity of the tetrafluoropropene of at least 99.95 wt % or at least 99.9 wt % or at least 99.8 wt % or at least 99.5 wt % or at least 99 wt %, the tetrafluoropropene procured or produced may be subject to purifications methods such as distillation and contacting with one or more adsorbents.

The tetrafluoropropene and hexafluorobutene may be combined by any known means. For example, these may be combined following purification steps as described above or following other purification steps known in the art.

The additional compounds, inhibitor and/or antioxidant may be added prior to or following combination of the tetrafluoropropene and hexafluorobutene.

### Applications

The compositions disclosed herein have a variety of utilities including working fluids, which include blowing agents, aerosol propellants, sterilants or, heat transfer mediums (such as heat transfer fluids and refrigerants for use in refrigeration systems, refrigerators, air conditioning systems, heat pumps, chillers, and the like), among others. The compositions are particularly suited for use in mobile air conditioning and heating systems and as a component for making a refrigerant blend for use in stationary refrigeration, air-conditioning and heat pump systems.

A blowing agent is a volatile composition that expands a polymer matrix to form a cellular structure.

An aerosol propellant is a volatile composition of one or more components that exerts a pressure greater than one atmosphere to expel a material from a container.

A sterilant is a volatile biocidal fluid or blend containing a volatile biocidal fluid that destroys a biologically active material or the like.

### Heat Transfer Applications

A heat transfer fluid (also referred to herein as a heat transfer composition or heat transfer fluid composition) is a working fluid used to carry heat from a heat source to a heat sink.

The present disclosure further relates to a process for transfer of heat from a heat source to a heat sink wherein the compositions disclosed herein serve as heat transfer fluids. Said process for heat transfer comprises transporting a composition comprising a tetrafluoropropene and a hexafluorobutene from a heat source to a heat sink.

A heat source is defined as any space, location, object or body from which it is desirable to add, transfer, move or remove heat. In one embodiment a heat source is a body to be cooled. In one embodiment, a heat source is a body to be heated.

In some embodiments, the heat transfer composition may remain in a constant state throughout the transfer process (i.e., not evaporate or condense). In other embodiments, evaporative cooling processes may utilize heat transfer compositions as well.

A heat sink may be defined as any space, location, object or body capable of absorbing heat. A vapor compression refrigeration system is one example of such a heat sink.

A body to be cooled may be any space location or object (the space location or object may be open or enclosed), requiring refrigeration or cooling. In stationary applications the body may be the interior of a structure, such as a residential or commercial structure requiring air-conditioning, industrial water chillers, or a storage location such as refrigerator or freezer cases in a supermarket, transport refrigerated containers other storage locations for perishables, such as food or pharmaceuticals. In mobile applications, the body may be incorporated into a transportation unit for the road, rail, sea or air, such as the passenger compartment of an automobile requiring air conditioning.

Certain refrigeration systems operate independently with regards to any moving carrier, these are known as “intermodal” systems. Such intermodal systems include “containers” (combined sea/land transport) as well as “swap bodies” (combined road and rail transport).

A body to be heated may be any space, location or object requiring heat. These may be the interior of structures either residential or commercial structures requiring heating, in a similar manner to the body to be cooled. Additionally, mobile units as described for cooling may be similar to those requiring heating. Certain transport units require heating to prevent the material being transported from solidifying inside the transport container.

A heat transfer system is the system (or apparatus) used to produce a heating or cooling effect in a particular space. A heat transfer system may be a mobile system or a stationary system. According to the disclosure herein, there is provided a heat transfer system comprising a composition comprising a tetrafluoropropene and a hexafluorobutene. In one embodiment, the heat transfer system is a stationary system chosen from a refrigeration, air-conditioning or heat pump apparatus. In one embodiment, the heat transfer system is a mobile system which is a mobile air-conditioning system.

A refrigerant is defined herein as a heat transfer fluid which undergoes a phase change from liquid to gas and back again during a cycle used to transfer of heat. There is provided herein a refrigerant comprising a tetrafluoropropene and a hexafluorobutene. In one embodiment, the refrigerant further comprises a lubricant. In one embodiment, the refrigerant comprises one or more added refrigerants (as defined hereinbelow).

The present disclosure further relates to a method for producing heating comprising evaporating a refrigerant comprising a tetrafluoropropene and a hexafluorobutene, and thereafter condensing said composition in the vicinity of a body to be heated. In one embodiment of this method, the refrigerant further comprises a lubricant.

The present disclosure further provides a method for producing cooling comprising condensing a refrigerant comprising a tetrafluoropropene and a hexafluorobutene, and thereafter evaporating said composition in the vicinity of a body to be cooled. In one embodiment of this method, the refrigerant further comprises a lubricant.

The present disclosure further provides a method for producing heating or cooling in a refrigeration, air-conditioning, or heat pump apparatus, said method comprising introducing a refrigerant into said apparatus having (a) a centrifugal compressor; (b) a multi-stage centrifugal compressor, or (c) a single slab/single pass heat exchanger; wherein said refrigerant or heat transfer fluid composition comprises a comprising a tetrafluoropropene and a hexafluorobutene. In one embodiment of this method, the refrigerant further comprises a lubricant.

### Lubricant

The lubricant component of the refrigerant compositions can comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. These include mineral oils and synthetic oils.

Mineral oils comprise paraffins (i.e. straight-chain and branched-carbon-chain, saturated hydrocarbons), naphthenes (i.e. cyclic or ring structure saturated hydrocarbons, which may be paraffins) and aromatics (i.e. unsaturated, cyclic hydrocarbons containing one or more rings characterized by alternating double bonds).

Synthetic oils comprise alkylaryls (i.e. linear and branched alkyl alkylbenzenes), synthetic paraffins and naphthenes, silicones, and poly-alpha-olefins.

The lubricant component may comprise those which have been designed for use with hydrofluorocarbon refrigerants and are miscible with compositions disclosed herein under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Michigan), and polyvinyl ethers (PVEs).

Lubricants for applications disclosed herein are selected by considering a given compressor's requirements and the environment to which the lubricant will be exposed. In one particular embodiment, the foregoing refrigerant compositions are combined with a PAG lubricant for usage in an automotive A/C system having an internal combustion engine. In another particular embodiment, the foregoing refrigerant compositions are combined with a POE lubricant for usage in an automotive A/C system having an electric or hybrid electric drive train.

### Added Refrigerants

In other embodiments, a refrigerant composition comprises a tetrafluoropropene and a hexafluorobutene and one or more added refrigerants. In one embodiment an added refrigerant comprises a hydrofluorocarbon. Examples of suitable hydrofluorocarbons include difluoromethane (HFC-32), pentafluoroethane (HFC-125), 1,1,1,2-tetrafluoroethane (HFC-134a), 1,1-difluoroethane (HFC-152a), 1,1,1,3,3,3-hexafluoropropane (HFC-236fa) and 1,1,1,2,2,3,3,3-heptafluoropropane (HFC-227ea).

In one particular embodiment, the added refrigerant comprises carbon dioxide.

The amount of added refrigerant can range from 10 to 90 wt %, 25 to 75 wt %, 30 to 60 wt % or 30 to 50 wt %.

### Refrigerant Additives

Additives which can improve the refrigerant and A/C lifetime and compressor durability are desirable. In one aspect of the invention, the inventive refrigerant composition is used to introduce lubricant into the A/C system as well as other additives, such as a) acid scavengers and b) flame suppressants.

### Acid Scavenger

An acid scavenger may comprise a siloxane, an activated aromatic compound, or a combination of both. Serrano et al. (paragraph 38 of US 2011/0272624 A1) disclose that the siloxane may be any molecule having a siloxy functionality. The siloxane may include an alkyl siloxane, an aryl siloxane, or a siloxane containing mixtures of aryl and alkyl substituents. For example, the siloxane may be an alkyl siloxane, including a dialkylsiloxane or a polydialkylsiloxane. Preferred siloxanes include an oxygen atom bonded to two silicon atoms, i.e., a group having the structure: SiOSi. Preferred siloxanes include siloxanes of having one or more of methyl, ethyl, propyl, or butyl groups.

In one aspect of the invention, the siloxane is an alkylsiloxane containing from about 1 to about 12 carbon atoms, such as hexamethyldisiloxane. The siloxane may also be a polymer such as polydialkylsiloxane, where the alkyl group is a methyl, ethyl, propyl, butyl, or any combination thereof. Suitable polydialkylsiloxanes have a molecular weight from about 100 to about 10,000. Highly preferred siloxanes include hexamethyldisiloxane, polydimethylsiloxane, and combinations thereof. The siloxane may consist essentially of polydimethylsiloxane, hexamethyldisiloxane, or a combination thereof.

The activated aromatic compound may be any aromatic molecule activated towards a Friedel-Crafts addition reaction, or mixtures thereof. An aromatic molecule activated towards a Friedel-Crafts addition reaction is defined to be any aromatic molecule capable of an addition reaction with mineral acids. Especially aromatic molecules capable of addition reactions with mineral acids either in the application environment (AC system) or during the ASHRAE 97:2007 “Sealed Glass Tube Method to Test the Chemical Stability of Materials for Use within Refrigerant Systems” thermal stability test.

The acid scavenger (e.g., the activated aromatic compound, the siloxane, or both) may be present in any concentration that results in a relatively low total acid number, a relatively low total halides concentration, a relatively low total organic acid concentration, or any combination thereof. Preferably the acid scavenger is present at a concentration greater than about 0.0050 wt %, more preferably greater than about 0.05 wt % and even more preferably greater than about 0.1 wt % (e.g. greater than about 0.5 wt %) based on the total weight of the refrigerant composition. The acid scavenger preferably is present in a concentration less than about 3 wt %, more preferably less than about 2.5 wt % and most preferably greater than about 2 wt % (e.g. less than about 1.8 wt %) based on the total Weight of the refrigerant composition.

### Flame Suppressants

Preferred flame suppressants include those described in patent application “Refrigerant compositions containing fluorine substituted olefins CA 2557873 A1” and incorporated by reference along with fluorinated products such as HFC-125 and/or Krytox® lubricants, also incorporated by reference and described in patent application “Refrigerant compositions comprising fluoroolefins and uses thereof WO2009018117A1.”

### Preparation of Refrigerant Composition

The refrigerant compositions of the present invention may be prepared by any convenient method to combine the desired amount of the individual components. A preferred method is to weigh the desired component amounts and thereafter combine the components in an appropriate vessel. Agitation may be used, if desired.

### Selected Embodiments

1. This Embodiment is a fluoroolefin composition comprising a tetrafluoropropene and a hexafluorobutene, wherein the tetrafluoropropene is tetrafluoropropene is 2,3,3,3-tetrafluoropropene or E-1,3,3,3-tetrafluoropropene or a combination of 2,3,3,3-tetrafluoropropene and E-1,3,3,3-tetrafluoropropene and the hexafluorobutene is E-1,1,1,4,4,4-hexafluoro-2-butene or Z-1,1,1,4,4,4-hexafluoro-2-butene or a combination of E-1,1,1,4,4,4-hexafluoro-2-butene and Z-1,1,1,4,4,4-hexafluoro-2-butene.
2. The fluoroolefin composition of Embodiment 1 wherein the tetrafluoropropene is 2,3,3,3-tetrafluoropropene.
3. The fluoroolefin composition of Embodiment 1 wherein the tetrafluoropropene is E-1,3,3,3-tetrafluoropropene.
4. The fluoroolefin composition of Embodiment 1 wherein the tetrafluoropropene is a combination of 2,3,3,3-tetrafluoropropene and E-1,3,3,3-tetrafluoropropene.
5. The fluoroolefin composition of any of Embodiments 1-4, wherein the hexafluorobutene is E-1,1,1,4,4,4-hexafluorobutene. In another embodiment, the hexafluorobutene is Z-1,1,1,4,4,4-hexafluorobutene (cis isomer). In another embodiment, the hexafluorobutene is a combination of both of E-1,1,1,4,4,4-hexafluoro-2-butene and Z-1,1,1,4,4,4-hexafluoro-2-butene.
6. The fluoroolefin composition of any of Embodiments 1-4, wherein the hexafluorobutene is Z-1,1,1,4,4,4-hexafluorobutene.
7. The fluoroolefin composition of any of Embodiments 1-4, wherein the hexafluorobutene is a combination of both of E-1,1,1,4,4,4-hexafluoro-2-butene and Z-1,1,1,4,4,4-hexafluoro-2-butene.
8. The fluoroolefin composition of any of Embodiments 1-7, wherein the tetrafluoropropene and hexafluorobutene comprise from 90 wt % up to 100 wt % of the fluoroolefin composition.
9. The fluoroolefin composition of any of Embodiments 1-7, wherein the tetrafluoropropene and hexafluorobutene comprise from 95.00 wt % to 99.99 wt % of the composition.
10. The fluoroolefin composition of any of Embodiments 1-7, wherein the tetrafluoropropene and hexafluorobutene comprise from 98.0 wt % to 99.8 wt % of the composition.
11. The fluoroolefin composition of any of Embodiments 1-10, wherein the tetrafluoropropene has a purity (concentration of 1234yf or E1234ze relative to other components of the tetrafluoropropene component of the fluoroolefin composition) of at least 99.95 wt %.
12. The fluoroolefin composition of any of Embodiments 1-10, wherein the tetrafluoropropene has a purity (concentration of 1234yf or E1234ze relative to other components of the tetrafluoropropene component of the fluoroolefin composition) of 99.9 wt %.
13. The fluoroolefin composition of any of Embodiments 1-10, wherein the tetrafluoropropene has a purity (concentration of 1234yf or E1234ze relative to other components of the tetrafluoropropene component of the fluoroolefin composition) of at least 99.8 wt %.
14. The fluoroolefin composition of any of Embodiments 1-10, wherein the tetrafluoropropene has a purity (concentration of 1234yf or E1234ze relative to other components of the tetrafluoropropene component of the fluoroolefin composition) of at least 99.5 wt %
15. The fluoroolefin composition of any of Embodiments 1-10, wherein the tetrafluoropropene has a purity (concentration of 1234yf or E1234ze relative to other components of the tetrafluoropropene component of the fluoroolefin composition) of at least 99 wt %.
16. The fluoroolefin composition of any of Embodiments 1-15, wherein the hexafluorobutene has a purity (concentration of Z- or E1336mzz relative to other components of the hexafluorobutene component of the fluoroolefin composition) of at least 99.95 wt %.
17. The fluoroolefin composition of any of Embodiments 1-15, wherein the hexafluorobutene has a purity (concentration of Z- or E1336mzz relative to other components of the hexafluorobutene component of the fluoroolefin composition) of at least 99.9 wt %.
18. The fluoroolefin composition of any of Embodiments 1-15, wherein the hexafluorobutene has a purity (concentration of Z- or E1336mzz relative to other components of the hexafluorobutene component of the fluoroolefin composition) of at least 99.8 wt %.
19. The fluoroolefin composition of any of Embodiments 1-15, wherein the hexafluorobutene has a purity (concentration of Z- or E1336mzz relative to other components of the hexafluorobutene component of the fluoroolefin composition) of at least 99.5 wt %
20. The fluoroolefin composition of any of Embodiments 1-15, wherein the hexafluorobutene has a purity (concentration of Z- or E1336mzz relative to other components of the hexafluorobutene component of the fluoroolefin composition) of at least 99 wt %.
21. The fluoroolefin composition of any of Embodiments 1-15, wherein the composition comprises one or more additional compounds chosen from HFC-32 (difluoromethane), HFC-125 (pentafluoroethane), HFC-134 (1,1,2,2-tetrafluoroethane), HFC-134a (1,1,1,2-tetrafluoroethane), HFC-152a (1,1-difluoroethane), HFC-161 (ethyl fluoride), HFC-227ea (1,1,1,2,2,3,3,3-heptafluoropropane), HFC-236fa (1,1,1,3,3,3-hexafluoropropane), HFO-1233zd (1-chloro-3,3,3-trifluoropropene), HFO-1224 yd (1-chloro-2,3,3,3-tetrafluoropropene), CO2, CC-40 (chloromethane), CFC-12 (dichlorodifluoromethane), HFC-23 (trifluoromethane), HCFC-124 (1-chloro-1,2,2.2-tetrafluoroethane), HCFC-124a (1-chloro-1,1,2,2-tetrafluoroethane), HCFC-142b (1-chloro-1,1-difluoroethane), HFC-143a (1,1,1-trifluoroethane), HFC-244bb (2-chloro-1,1,1,2-tetrafluoropropane), HFC-245cb (1,1,1,2,2-pentafluoropropane), HFC-254eb (1,1,1,2-tetrafluoropropane), HFC-263fb (1,1,1-trifluoropropane), HFO-1123 (1,1,2-trifluoroethylene), HFO-1243zf (3,3,3-trifluoropropene), HFO-1225ye (E- or Z-1,2,3,3,3-pentafluoropropene), HFO-1225zc (1,1,3,3,3-pentafluoropropene), 3,3,3-trifluoro-1-propyne, HCFO-1233xf (2-chloro-3,3,3-trifluoropropene), HCFO-1122 (2-chloro-1,1-difluoroethylene), HCO-1140 (vinyl chloride), HCFO-1131 (E- and/or Z-1-chloro-2-fluoroethylene), and HCFO-1131a (1-chloro-1-fluoroethylene).
22. The fluoroolefin composition of any of Embodiments 1-15, wherein the composition comprises one or more additional compounds chosen from HFC-32 (difluoromethane), HFC-125 (pentafluoroethane), HFC-134 (1,1,2,2-tetrafluoroethane), HFC-134a (1,1,1,2-tetrafluoroethane), HFC-152a (1,1-difluoroethane), HFC-161 (ethyl fluoride), HFC-227ea (1,1,1,2,2,3,3,3-heptafluoropropane), HFC-236fa (1,1,1,3,3,3-hexafluoropropane), HFO-1233zd (1-chloro-3,3,3-trifluoropropene), HFO-1224 yd (1-chloro-2,3,3,3-tetrafluoropropene) and CO2.
23. The fluoroolefin composition of any of Embodiments 1-15, wherein the composition comprises one or more additional compounds chosen from CC-40 (chloromethane), CFC-12 (dichlorodifluoromethane), HFC-23 (trifluoromethane), HCFC-124 (1-chloro-1,2,2,2-tetrafluoroethane), HCFC-124a (1-chloro-1,1,2,2-tetrafluoroethane), HCFC-142b (1-chloro-1,1-difluoroethane), HFC-143a (1,1,1-trifluoroethane), HFC-244bb (2-chloro-1,1,1,2-tetrafluoropropane), HFC-245cb (1,1,1,2,2-pentafluoropropane), HFC-245fa (1,1,1,3,3-pentafluoropropane), HFC-254eb (1,1,1,2-tetrafluoropropane), HFC-263fb (1,1,1-trifluoropropane), HFO-1123 (1,1,2-trifluoroethylene), HFO-1243zf (3,3,3-trifluoropropene), HFO-1225ye (E- or Z-1,2,3,3,3-pentafluoropropene), HFO-1225zc (1,1,3,3,3-pentafluoropropene), 3,3,3-trifluoro-1-propyne, HCFO-1233xf (2-chloro-3,3,3-trifluoropropene), HCFO-1122 (2-chloro-1,1-difluoroethylene), HFO-1132 (E- and/or Z-1,2-difluoroethylene), HCFO-1132a (1,1-difluoroethylene), HCO-1140 (vinyl chloride), HCFO-1131 (E- and/or Z-1-chloro-2-fluoroethylene), and HCFO-1131a (1.chloro-1-fluoroethylene).
24. The fluoroolefin composition of any of Embodiments 1-15, wherein the composition comprises one or more additional compounds chosen from HFO-1243zf, HFC-134a, HCFO-1122, HFC-254eb, HCFC-124 and HFC-23.
25. The fluoroolefin composition of any of Embodiments 1-15, wherein the composition comprises HFO-1243zf, HFC-134a and HFC-143a.
26. The fluoroolefin composition of any of Embodiments 1-15, wherein the composition comprises HFO-1243zf, HFC-134a, HFC-143a, HCFO-1122 and HFC-254eb.
27. The fluoroolefin composition of any of Embodiments 1-15, wherein the tetrafluoropropene is a combination of 1234yf and E1234ze and further comprises an additional compound chosen from one or more of HFC-152a, HCFO-1131a, HCO-1140, CFC-12, HFC-244bb and HCFO-1233xf.
28. The fluoroolefin composition of any of Embodiments 1-15, wherein the tetrafluoropropene is a combination of 1234yf and E1234ze, and the additional compound is HFC-152a.
29. The fluoroolefin composition of any of Embodiments 1-15, wherein the tetrafluoropropene is a combination of 1234yf and E1234ze, the additional compound is a combination of HFC-152a, HCFO-1131a, HCO-1140, HFC-244bb and HCFO-1233xf.
30. The fluoroolefin composition of Embodiment 23, wherein the additional compound is chosen from one or more of Z-HFO-1225ye, HC-40, E-HFO-1132 and HFC-263fb.
31. The fluoroolefin composition of Embodiment 23, wherein the additional compound is a combination of Z-HFO-1225ye, E-HFO-1132 and HFC-263fb.
32. The fluoroolefin composition of Embodiment 23 wherein the amount of the one or more additional compound is greater than 0 wt % and less than 1 wt %.
33. The fluoroolefin composition of Embodiment 23 wherein the amount of the one or more additional compound is greater than 0.1 ppm and less than 0.5 wt % of the total weight of the composition.
34. The fluoroolefin composition of Embodiment 23 wherein the amount of the one or more additional compound is greater than 1 ppm and less than 0.1 wt % of the total weight of the composition.
35. The fluoroolefin composition of Embodiment 23 wherein the amount of the one or more additional compound is greater than 10 ppm or greater than 100 ppm or greater than 1000 ppm.
36. A refrigerant composition comprising the fluoroolefin composition of Embodiment 1 and a lubricant.
37. The refrigerant composition of Embodiment 36 further comprising an added refrigerant.
38. The refrigerant of Embodiment 37 wherein the added refrigerant is a hydrofluorocarbon.
39. The refrigerant composition of Embodiment 38 wherein the hydrofluorocarbon is chosen from HFC-32, HFC-125, HFC-134a, HFC-152a, 236fa and HFC-227ea.
40. The refrigerant of Embodiment 37 wherein the added refrigerant is carbon dioxide.
41. A process for heat transfer comprising transporting a composition comprising the composition of Embodiment 1 from a heat source to a heat sink.
42. A method for producing cooling comprising condensing a refrigerant, and thereafter evaporating said composition in the vicinity of a body to be cooled, wherein the refrigerant is the composition of any of Embodiments 36-40.
43. A method for producing heating comprising evaporating a refrigerant, and thereafter condensing said composition in the vicinity of a body to be heated, wherein the refrigerant is the composition of any of Embodiments 36-40.
44. A method for producing heating or cooling in a refrigeration, air-conditioning, or heat pump apparatus, said method comprising introducing a refrigerant into said apparatus having (a) a centrifugal compressor; (b) a multi-stage centrifugal compressor, or (c) a single slab/single pass heat exchanger; wherein said refrigerant is the composition of any of Embodiments 36-40.
45. A heat transfer system comprising the fluoroolefin composition of any of Embodiments 1-35.
46. The system of Embodiment 45 wherein the heat transfer system is a stationary system chosen from a refrigeration, air-conditioning or heat pump apparatus.
47. The heat transfer system of Embodiment 45, wherein the heat transfer system is a mobile system which is a mobile air-conditioning system.

### EXAMPLES

### Example 1

Compositions are prepared by mixing the components in the amounts recited. The refrigeration performances of these compositions were determined and are provided in Tables 2-8.

### Cycle Input Parameters:

T_condenser=46.1° C.
T_evaporator=10° C.
subcool=8.3 K
superheat=11.1 K
compressor efficiency=70%

TABLE 2
Baseline Performance of Components

| | | | | Evap | Cond | | | | |
|---|---|---|---|---|---|---|---|---|---|
| Component and Amount, wt % | | | | P | P | Comp | Average | Capacity | |
| 1234yf | E1234ze | E1336mzz | Z1336mzz | (kPa) | (kPa) | Exit C | Glide (K) | (kJ/m3) | COP |
| 100 | | | | 438 | 1185 | 60.7 | 0.0 | 2947 | 4.771 |
| | 100 | | | 308 | 902 | 63.3 | 0.0 | 2332 | 4.896 |
| | | 100 | | 110 | 383 | 55.3 | 0.0 | 983 | 4.964 |
| | | | 100 | 39.4 | 158 | 58.1 | 0.0 | 406.6 | 5.083 |

TABLE 3
Performance of 1234yf - E1336mzz Compositions

| | | | | | | | Cap | | COP |
|---|---|---|---|---|---|---|---|---|---|
| Component and | | | | Comp | Average | | Rel to | | Rel to |
| Amount, wt % | | Evap P | Cond P | Exit | Glide | Capacity | 1234yf | | 1234yf |
| 1234yf | E1336mzz | (kPa) | (kPa) | C | (K) | (kJ/m³) | % | COP | % |
| 100 | | 438 | 1185 | 60.7 | 0.0 | 2947 | 100.0% | 4.771 | 100.0% |
| | 100 | 110 | 383 | 55.3 | 0.0 | 983 | 33.4% | 4.964 | 104.0% |
| 99.9 | 0.1 | 437 | 1185 | 60.7 | 0.0 | 2945 | 99.9% | 4.771 | 100.0% |
| 99 | 1 | 434 | 1178 | 60.8 | 0.2 | 2929 | 99.4% | 4.772 | 100.0% |
| 90 | 10 | 399 | 1108 | 61.5 | 1.8 | 2763 | 93.8% | 4.780 | 100.2% |
| 80 | 20 | 361 | 1029 | 62.3 | 3.8 | 2576 | 87.4% | 4.794 | 100.5% |
| 70 | 30 | 325 | 950 | 63.1 | 5.7 | 2389 | 81.1% | 4.818 | 101.0% |
| 60 | 40 | 290 | 870 | 63.6 | 7.5 | 2204 | 74.8% | 4.854 | 101.7% |
| 50 | 50 | 257 | 791 | 63.8 | 8.9 | 2021 | 68.6% | 4.901 | 102.7% |
| 40 | 60 | 225 | 713 | 63.7 | 9.8 | 1836 | 62.3% | 4.947 | 103.7% |
| 30 | 70 | 195 | 636 | 63.0 | 9.8 | 1644 | 55.8% | 4.979 | 104.4% |
| 26 | 74 | 183 | 605 | 62.5 | 9.5 | 1563 | 53.0% | 4.984 | 104.5% |
| 20 | 80 | 166 | 558 | 61.7 | 8.6 | 1437 | 48.8% | 4.981 | 104.4% |
| 10 | 90 | 137 | 476 | 59.4 | 5.6 | 1215 | 41.2% | 4.955 | 103.9% |
| 1 | 99 | 113 | 393 | 55.8 | 0.7 | 1006 | 34.1% | 4.957 | 103.9% |
| 0.1 | 99.9 | 111 | 384 | 55.4 | 0.1 | 985 | 33.4% | 4.963 | 104.0% |

TABLE 4
Performance of 1234yf - Z1336mzz Compositions

| | | | | | | | Cap Rel | | COP |
|---|---|---|---|---|---|---|---|---|---|
| Component and | | Evap | Cond | | Average | | to | | Rel to |
| Amount, wt % | | P | P | Comp | Glide | Capacity | 1234yf | | 1234yf |
| 1234yf | Z1336mzz | (kPa) | (kPa) | Exit C | (K) | (kJ/m³) | % | COP | % |
| 100 | | 438 | 1185 | 60.7 | 0.0 | 2947 | 100.0% | 4.771 | 100.0% |
| | 100 | 39.4 | 158 | 58.1 | 0.0 | 406.6 | 13.8% | 5.083 | 106.5% |
| 99.9 | 0.1 | 436 | 1183 | 60.8 | 0.1 | 2941 | 99.8% | 4.770 | 100.0% |
| 99 | 1 | 425 | 1163 | 61.6 | 1.1 | 2888 | 98.0% | 4.758 | 99.7% |
| 90 | 10 | 333 | 985 | 67.7 | 9.9 | 2456 | 83.3% | 4.749 | 99.5% |
| 80 | 20 | 266 | 828 | 71.6 | 17.1 | 2115 | 71.8% | 4.859 | 101.8% |
| 70 | 30 | 219 | 705 | 73.7 | 22.1 | 1850 | 62.8% | 5.003 | 104.9% |
| 60 | 40 | 182 | 603 | 74.7 | 25.3 | 1623 | 55.1% | 5.140 | 107.7% |
| 50 | 50 | 151 | 517 | 74.9 | 26.9 | 1414 | 48.0% | 5.246 | 110.0% |
| 40 | 60 | 123 | 440 | 74.3 | 26.9 | 1209 | 41.0% | 5.298 | 111.0% |
| 30 | 70 | 98.4 | 370 | 72.8 | 24.9 | 999.8 | 33.9% | 5.271 | 110.5% |
| 26 | 74 | 89.0 | 342 | 72.0 | 23.4 | 914.8 | 31.0% | 5.235 | 109.7% |
| 20 | 80 | 75.5 | 302 | 70.3 | 20.3 | 787.0 | 26.7% | 5.157 | 108.1% |
| 10 | 90 | 55.1 | 233 | 66.0 | 12.5 | 581.6 | 19.7% | 5.008 | 105.0% |
| 1 | 99 | 40.7 | 165 | 59.1 | 1.5 | 421.9 | 14.3% | 5.046 | 105.8% |
| 0.1 | 99.9 | 39.5 | 158 | 58.2 | 0.2 | 408.1 | 13.8% | 5.078 | 106.4% |

TABLE 5
Performance of 1234yf - E1336mzz - Z1336mzz Compositions

| | | | | | | Average |
|---|---|---|---|---|---|---|
| Component and Amount, wt % | | | Evap P | Cond P | Comp | Glide |
| 1234yf | E1336mzz | Z1336mzz | (kPa) | (kPa) | Exit C | (K) |
| 100 | | | 438 | 1185 | 60.7 | 0.0 |
| | 100 | | 110 | 383 | 55.3 | 0.0 |
| | | 100 | 39.4 | 158 | 58.1 | 0.0 |
| 99.9 | 0.05 | 0.05 | 437 | 1184 | 60.7 | 0.1 |
| 99 | 0.5 | 0.5 | 429 | 1170 | 61.2 | 0.7 |
| 90 | 9 | 1 | 391 | 1094 | 62.3 | 2.8 |
| 90 | 5 | 5 | 362 | 1042 | 65.0 | 6.3 |
| 90 | 1 | 9 | 339 | 996 | 67.2 | 9.3 |
| 80 | 5 | 15 | 283 | 868 | 70.0 | 14.6 |
| 80 | 10 | 10 | 303 | 914 | 68.1 | 11.6 |
| 80 | 15 | 5 | 268 | 831 | 69.7 | 14.9 |
| 70 | 10 | 20 | 242 | 766 | 71.6 | 18.3 |
| 70 | 15 | 15 | 256 | 802 | 70.2 | 16.0 |
| 70 | 20 | 10 | 274 | 844 | 68.4 | 13.2 |
| 60 | 10 | 30 | 198 | 649 | 73.3 | 22.7 |
| 60 | 20 | 20 | 218 | 704 | 71.3 | 19.3 |
| 60 | 30 | 10 | 246 | 775 | 68.5 | 14.5 |
| 50 | 10 | 40 | 163 | 552 | 73.9 | 25.3 |
| 50 | 25 | 25 | 186 | 617 | 71.7 | 21.5 |
| 50 | 40 | 10 | 220 | 706 | 68.2 | 15.4 |
| 40 | 10 | 50 | 133 | 469 | 73.6 | 25.9 |
| 40 | 30 | 30 | 157 | 538 | 71.5 | 22.5 |
| 40 | 50 | 10 | 194 | 639 | 67.6 | 15.7 |
| 30 | 10 | 60 | 106 | 393 | 72.5 | 24.6 |
| 30 | 35 | 35 | 131 | 465 | 70.6 | 22.0 |
| 30 | 60 | 10 | 169 | 571 | 66.5 | 15.1 |
| 26 | 12 | 62 | 97.6 | 369 | 71.6 | 23.3 |
| 26 | 37 | 37 | 120 | 436 | 70.1 | 21.3 |
| 26 | 62 | 12 | 155 | 533 | 66.4 | 15.3 |
| 20 | 10 | 70 | 81.6 | 321 | 70.2 | 20.6 |
| 20 | 40 | 40 | 105 | 393 | 68.9 | 19.5 |
| 20 | 70 | 10 | 143 | 502 | 64.8 | 13.3 |
| 10 | 10 | 80 | 59.7 | 248 | 66.1 | 13.2 |
| 10 | 45 | 45 | 81.1 | 318 | 65.6 | 14.2 |
| 10 | 80 | 10 | 118 | 427 | 62.1 | 9.5 |
| 1 | 90 | 9 | 98.4 | 354 | 57.9 | 3.5 |
| 1 | 49.5 | 49.5 | 62.3 | 243 | 60.4 | 6.0 |
| 1 | 9 | 90 | 43.5 | 176 | 59.5 | 2.5 |
| 0.1 | 99 | 0.9 | 109 | 380 | 55.6 | 0.4 |
| 0.1 | 49.95 | 49.95 | 60.6 | 234 | 59.7 | 4.9 |
| 0.1 | 0.9 | 99 | 39.7 | 159 | 58.2 | 0.2 |

TABLE 5
Performance of 1234yf - E1336mzz - Z1336mzz Compositions (continued)

| | | | | Cap Rel | | COP Rel |
|---|---|---|---|---|---|---|
| Component and Amount, wt % | | | Capacity | to 1234yf | | to 1234yf |
| 1234yf | E1336mzz | Z1336mzz | (kJ/m3) | % | COP | % |
| 100 | | | 2947 | 100.0% | 4.771 | 100.0% |
| | 100 | | 983 | 33.4% | 4.964 | 104.0% |
| | | 100 | 406.6 | 13.8% | 5.083 | 106.5% |
| 99.9 | 0.05 | 0.05 | 2943 | 99.9% | 4.770 | 100.0% |
| 99 | 0.5 | 0.5 | 2908 | 98.7% | 4.765 | 99.9% |
| 90 | 9 | 1 | 2724 | 92.4% | 4.767 | 99.9% |
| 90 | 5 | 5 | 2589 | 87.9% | 4.743 | 99.4% |
| 90 | 1 | 9 | 2480 | 84.2% | 4.746 | 99.5% |
| 80 | 5 | 15 | 2198 | 74.6% | 4.819 | 101.0% |
| 80 | 10 | 10 | 2295 | 77.9% | 4.786 | 100.3% |
| 80 | 15 | 5 | 2113 | 71.7% | 4.848 | 101.6% |
| 70 | 10 | 20 | 1976 | 67.1% | 4.918 | 103.1% |
| 70 | 15 | 15 | 2050 | 69.6% | 4.875 | 102.2% |
| 70 | 20 | 10 | 2138 | 72.5% | 4.835 | 101.3% |
| 60 | 10 | 30 | 1722 | 58.4% | 5.068 | 106.2% |
| 60 | 20 | 20 | 1836 | 62.3% | 4.983 | 104.4% |
| 60 | 30 | 10 | 1983 | 67.3% | 4.895 | 102.6% |
| 50 | 10 | 40 | 1497 | 50.8% | 5.195 | 108.9% |
| 50 | 25 | 25 | 1640 | 55.6% | 5.090 | 106.7% |
| 50 | 40 | 10 | 1827 | 62.0% | 4.958 | 103.9% |
| 40 | 10 | 50 | 1282 | 43.5% | 5.270 | 110.5% |
| 40 | 30 | 30 | 1447 | 49.1% | 5.171 | 108.4% |
| 40 | 50 | 10 | 1666 | 56.5% | 5.013 | 105.1% |
| 30 | 10 | 60 | 1064 | 36.1% | 5.266 | 110.4% |
| 30 | 35 | 35 | 1248 | 42.3% | 5.202 | 109.0% |
| 30 | 60 | 10 | 1493 | 50.7% | 5.043 | 105.7% |
| 26 | 12 | 62 | 988.7 | 33.5% | 5.237 | 109.8% |
| 26 | 37 | 37 | 1165 | 39.5% | 5.195 | 108.9% |
| 26 | 62 | 12 | 1395 | 47.3% | 5.059 | 106.0% |
| 20 | 10 | 70 | 842.3 | 28.6% | 5.169 | 108.3% |
| 20 | 40 | 40 | 1037 | 35.2% | 5.162 | 108.2% |
| 20 | 70 | 10 | 1302 | 44.2% | 5.035 | 105.5% |
| 10 | 10 | 80 | 625.2 | 21.2% | 5.026 | 105.3% |
| 10 | 45 | 45 | 817.0 | 27.7% | 5.071 | 106.3% |
| 10 | 80 | 10 | 1094 | 37.1% | 4.996 | 104.7% |
| 1 | 90 | 9 | 908.9 | 30.8% | 4.994 | 104.7% |
| 1 | 49.5 | 49.5 | 625.7 | 21.2% | 5.069 | 106.2% |
| 1 | 9 | 90 | 450.4 | 15.3% | 5.049 | 105.8% |
| 0.1 | 99 | 0.9 | 974.1 | 33.1% | 4.967 | 104.1% |
| 0.1 | 49.95 | 49.95 | 607.7 | 20.6% | 5.086 | 106.6% |
| 0.1 | 0.9 | 99 | 410.7 | 13.9% | 5.078 | 106.4% |

TABLE 6
Performance of E1234ze - E1336mzz Compositions

| | | | | | | | Cap Rel | | COP Rel |
|---|---|---|---|---|---|---|---|---|---|
| Component and | | Evap | Cond | | Average | | to | | to |
| Amount, wt % | | P | P | Comp | Glide | Capacity | 1234zeE | | 1234zeE |
| E1234ze | E1336mzz | (kPa) | (kPa) | Exit C | (K) | (kJ/m3) | % | COP | % |
| 100 | | 308 | 902 | 63.3 | 0.0 | 2332 | 100.0% | 4.896 | 100.0% |
| | 100 | 110 | 383 | 55.3 | 0.0 | 983 | 42.2% | 4.964 | 101.4% |
| | | 39.4 | 158 | 58.1 | 0.0 | 406.6 | 17.4% | 5.083 | 103.8% |
| 99.9 | 0.1 | 308 | 901 | 63.3 | 0.0 | 2331 | 100.0% | 4.896 | 100.0% |
| 99 | 1 | 307 | 898 | 63.3 | 0.1 | 2320 | 99.5% | 4.896 | 100.0% |
| 90 | 10 | 290 | 859 | 63.2 | 1.0 | 2217 | 95.1% | 4.899 | 100.1% |
| 80 | 20 | 270 | 813 | 63.1 | 2.0 | 2099 | 90.0% | 4.903 | 100.1% |
| 70 | 30 | 250 | 766 | 63.0 | 3.1 | 1976 | 84.7% | 4.911 | 100.3% |
| 60 | 40 | 230 | 717 | 62.8 | 4.1 | 1851 | 79.4% | 4.924 | 100.6% |
| 50 | 50 | 210 | 667 | 62.5 | 4.9 | 1723 | 73.9% | 4.942 | 100.9% |
| 40 | 60 | 190 | 615 | 62.0 | 5.5 | 1592 | 68.3% | 4.961 | 101.3% |
| 33 | 67 | 176 | 578 | 61.5 | 5.6 | 1497 | 64.2% | 4.972 | 101.6% |
| 30 | 70 | 170 | 562 | 61.2 | 5.6 | 1455 | 62.4% | 4.976 | 101.6% |
| 20 | 80 | 150 | 507 | 60.0 | 5.0 | 1309 | 56.1% | 4.980 | 101.7% |
| 10 | 90 | 130 | 448 | 58.2 | 3.3 | 1151 | 49.4% | 4.969 | 101.5% |
| 1 | 99 | 112 | 390 | 55.7 | 0.4 | 1000 | 42.9% | 4.965 | 101.4% |
| 0.1 | 99.9 | 111 | 384 | 55.4 | 0.0 | 984.5 | 42.2% | 4.964 | 101.4% |

TABLE 7
Performance of E1234ze - Z1336mzz Compositions

| | | | | | | | Cap Rel | | COP Rel |
|---|---|---|---|---|---|---|---|---|---|
| Component and | | Evap | Cond | | Average | | to | | to |
| Amount, wt % | | P | P | Comp | Glide | Capacity | 1234zeE | | 1234zeE |
| E1234ze | Z1336mzz | (kPa) | (kPa) | Exit C | (K) | (kJ/m3) | % | COP | % |
| 100 | | 308 | 902 | 63.3 | 0.0 | 2332 | 100.0% | 4.896 | 100.0% |
| | | 110 | 383 | 55.3 | 0.0 | 983 | 42.2% | 4.964 | 101.4% |
| | 100 | 39.4 | 158 | 58.1 | 0.0 | 406.6 | 17.4% | 5.083 | 103.8% |
| 99.9 | 0.1 | 307 | 900 | 63.4 | 0.1 | 2327 | 99.8% | 4.895 | 100.0% |
| 99 | 1 | 301 | 886 | 64.0 | 0.9 | 2288 | 98.1% | 4.887 | 99.8% |
| 90 | 10 | 244 | 764 | 68.4 | 7.8 | 1970 | 84.5% | 4.885 | 99.8% |
| 80 | 20 | 202 | 656 | 71.0 | 13.1 | 1715 | 73.5% | 4.959 | 101.3% |
| 70 | 30 | 170 | 569 | 72.2 | 16.6 | 1508 | 64.7% | 5.050 | 103.1% |
| 60 | 40 | 143 | 494 | 72.6 | 18.8 | 1327 | 56.9% | 5.132 | 104.8% |
| 50 | 50 | 121 | 429 | 72.3 | 19.8 | 1160 | 49.7% | 5.190 | 106.0% |
| 40 | 60 | 101 | 370 | 71.4 | 19.4 | 998.1 | 42.8% | 5.214 | 106.5% |
| 33 | 67 | 87.9 | 331 | 70.3 | 18.3 | 886.9 | 38.0% | 5.205 | 106.3% |
| 30 | 70 | 82.7 | 315 | 69.8 | 17.5 | 839.5 | 36.0% | 5.195 | 106.1% |
| 20 | 80 | 66.1 | 262 | 67.3 | 13.9 | 684.2 | 29.3% | 5.132 | 104.8% |
| 10 | 90 | 51.5 | 210 | 63.6 | 8.3 | 536.7 | 23.0% | 5.057 | 103.3% |
| 1 | 99 | 40.4 | 163 | 58.8 | 1.0 | 418.5 | 17.9% | 5.069 | 103.5% |
| 0.1 | 99.9 | 39.5 | 158 | 58.2 | 0.1 | 407.8 | 17.5% | 5.081 | 103.8% |

TABLE 8
Performance of E1234ze - E1336mzz - Z1336mzz Compositions

| | | | | | | Average |
|---|---|---|---|---|---|---|
| Component and Amount, wt % | | | Evap P | Cond P | Comp | Glide |
| E1234ze | E1336mzz | Z1336mzz | (kPa) | (kPa) | Exit C | (K) |
| 100 | | | 308 | 902 | 63.3 | 0.0 |
| | 100 | | 110 | 383 | 55.3 | 0.0 |
| | | 100 | 39.4 | 158 | 58.1 | 0.0 |
| 99.9 | 0.05 | 0.05 | 308 | 901 | 63.3 | 0.1 |
| 99 | 0.5 | 0.5 | 303 | 892 | 63.6 | 0.5 |
| 90 | 9 | 1 | 284 | 848 | 63.9 | 1.8 |
| 90 | 5 | 5 | 264 | 807 | 66.2 | 4.7 |
| 90 | 1 | 9 | 248 | 772 | 68.0 | 7.2 |
| 80 | 5 | 15 | 214 | 687 | 69.7 | 11.0 |
| 80 | 10 | 10 | 229 | 723 | 68.0 | 8.6 |
| 80 | 15 | 5 | 247 | 764 | 66.0 | 5.7 |
| 70 | 10 | 20 | 188 | 618 | 70.4 | 13.7 |
| 70 | 15 | 15 | 199 | 648 | 69.2 | 11.7 |
| 70 | 20 | 10 | 212 | 681 | 67.7 | 9.4 |
| 60 | 10 | 30 | 157 | 533 | 71.4 | 16.9 |
| 60 | 20 | 20 | 174 | 580 | 69.7 | 14.1 |
| 60 | 30 | 10 | 196 | 638 | 67.2 | 10.1 |
| 50 | 10 | 40 | 132 | 460 | 71.5 | 18.6 |
| 50 | 25 | 25 | 151 | 517 | 69.7 | 15.7 |
| 50 | 40 | 10 | 180 | 594 | 66.5 | 10.6 |
| 40 | 10 | 50 | 110 | 396 | 70.9 | 18.8 |
| 40 | 30 | 30 | 131 | 459 | 69.2 | 16.4 |
| 40 | 50 | 10 | 163 | 549 | 65.6 | 10.7 |
| 33 | 12 | 55 | 97.0 | 359 | 70.0 | 18.1 |
| 33 | 34 | 33 | 118 | 421 | 68.5 | 16.2 |
| 33 | 55 | 12 | 148 | 506 | 65.3 | 11.3 |
| 30 | 10 | 60 | 89.7 | 337 | 69.6 | 17.6 |
| 30 | 35 | 35 | 112 | 404 | 68.2 | 16.0 |
| 30 | 60 | 10 | 147 | 502 | 64.5 | 10.4 |
| 20 | 10 | 70 | 71.7 | 281 | 67.3 | 14.5 |
| 20 | 40 | 40 | 93.6 | 349 | 66.5 | 14.3 |
| 20 | 70 | 10 | 130 | 453 | 62.9 | 9.2 |
| 10 | 10 | 80 | 55.8 | 226 | 63.9 | 9.2 |
| 10 | 45 | 45 | 76.3 | 294 | 63.9 | 10.8 |
| 10 | 80 | 10 | 112 | 400 | 60.7 | 6.9 |
| 1 | 90 | 9 | 97.9 | 351 | 57.7 | 3.2 |
| 1 | 49.5 | 49.5 | 61.9 | 240 | 60.2 | 5.5 |
| 1 | 9 | 90 | 43.3 | 174 | 59.1 | 1.9 |
| 0.1 | 99 | 0.9 | 109 | 380 | 55.6 | 0.4 |
| 0.1 | 49.95 | 49.95 | 61.9 | 240 | 60.2 | 5.5 |
| 0.1 | 0.9 | 99 | 39.7 | 159 | 58.2 | 0.2 |

TABLE 8
Performance of E1234ze - E1336mzz - Z1336mzz Compositions (Continued)

| | | | | Cap Rel | | COP Rel |
|---|---|---|---|---|---|---|
| | | | | to | | to |
| Component and Amount, wt % | | | Capacity | 1234zeE | | 1234zeE |
| E1234ze | E1336mzz | Z1336mzz | (kJ/m3) | % | COP | % |
| 100 | | | 2332 | 100.0% | 4.896 | 100.0% |
| | 100 | | 983 | 42.2% | 4.964 | 101.4% |
| | | 100 | 406.6 | 17.4% | 5.083 | 103.8% |
| 99.9 | 0.05 | 0.05 | 2329 | 99.9% | 4.895 | 100.0% |
| 99 | 0.5 | 0.5 | 2304 | 98.8% | 4.891 | 99.9% |
| 90 | 9 | 1 | 2186 | 93.7% | 4.890 | 99.9% |
| 90 | 5 | 5 | 2078 | 89.1% | 4.876 | 99.6% |
| 90 | 1 | 9 | 1990 | 85.3% | 4.882 | 99.7% |
| 80 | 5 | 15 | 1786 | 76.6% | 4.929 | 100.7% |
| 80 | 10 | 10 | 1868 | 80.1% | 4.903 | 100.1% |
| 80 | 15 | 5 | 1968 | 84.4% | 4.888 | 99.8% |
| 70 | 10 | 20 | 1621 | 69.5% | 4.987 | 101.9% |
| 70 | 15 | 15 | 1687 | 72.3% | 4.955 | 101.2% |
| 70 | 20 | 10 | 1764 | 75.6% | 4.925 | 100.6% |
| 60 | 10 | 30 | 1418 | 60.8% | 5.080 | 103.8% |
| 60 | 20 | 20 | 1524 | 65.4% | 5.018 | 102.5% |
| 60 | 30 | 10 | 1657 | 71.1% | 4.952 | 101.1% |
| 50 | 10 | 40 | 1238 | 53.1% | 5.156 | 105.3% |
| 50 | 25 | 25 | 1372 | 58.8% | 5.080 | 103.8% |
| 50 | 40 | 10 | 1547 | 66.3% | 4.981 | 101.7% |
| 40 | 10 | 50 | 1067 | 45.8% | 5.198 | 106.2% |
| 40 | 30 | 30 | 1224 | 52.5% | 5.129 | 104.8% |
| 40 | 50 | 10 | 1433 | 61.4% | 5.008 | 102.3% |
| 33 | 12 | 55 | 963.0 | 41.3% | 5.199 | 106.2% |
| 33 | 34 | 33 | 1124 | 48.2% | 5.147 | 105.1% |
| 33 | 55 | 12 | 1324 | 56.8% | 5.035 | 102.8% |
| 30 | 10 | 60 | 900.0 | 38.6% | 5.195 | 106.1% |
| 30 | 35 | 35 | 1075 | 46.1% | 5.152 | 105.2% |
| 30 | 60 | 10 | 1311 | 56.2% | 5.026 | 102.7% |
| 20 | 10 | 70 | 735.8 | 31.6% | 5.143 | 105.0% |
| 20 | 40 | 40 | 921.4 | 39.5% | 5.140 | 105.0% |
| 20 | 70 | 10 | 1178 | 50.5% | 5.028 | 102.7% |
| 10 | 10 | 80 | 578.2 | 24.8% | 5.069 | 103.5% |
| 10 | 45 | 45 | 762.9 | 32.7% | 5.097 | 104.1% |
| 10 | 80 | 10 | 1034 | 44.3% | 5.013 | 102.4% |
| 1 | 90 | 9 | 903.3 | 38.7% | 5.001 | 102.1% |
| 1 | 49.5 | 49.5 | 621.1 | 26.6% | 5.083 | 103.8% |
| 1 | 9 | 90 | 446.8 | 19.2% | 5.070 | 103.6% |
| 0.1 | 99 | 0.9 | 973.6 | 41.7% | 4.967 | 101.5% |
| 0.1 | 49.95 | 49.95 | 621.1 | 26.6% | 5.083 | 103.8% |
| 0.1 | 0.9 | 99 | 410.4 | 17.6% | 5.081 | 103.8% |

TABLE 9
Performance of 1234yf - E1336mzz and Additional Compounds Compositions

| | | | | | | | | COP Rel |
|---|---|---|---|---|---|---|---|---|
| Component and Amount, wt % | | | | | | | | to 1234yf |
| 1234yf | 1336mzz(E) | 1243zf | 1225yeZ | 245cb | 236fa | 245fa | COP | % |
| 100 | | | | | | | 4.771 | 100.0% |
| 80 | 20 | | | | | | 4.815 | 100.9% |
| 72 | 18 | 10 | | | | | 4.817 | 101.0% |
| 72 | 18 | | 10 | | | | 4.817 | 101.0% |
| 72 | 18 | | | 10 | | | 4.821 | 101.0% |
| 72 | 18 | | | | 10 | | 4.838 | 101.4% |
| 72 | 18 | | | | | 10 | 4.867 | 102.0% |

As can be seen from the performance results in Tables 3-9 by combining a tetrafluoropropene with a hexafluorobutene improvements in refrigeration performance relative to the tetrafluoropropene alone or the hexafluorobutene alone can be achieved, depending on whether the target is improved capacity or improved efficiency.

1. A fluoroolefin composition comprising a tetrafluoropropene and a hexafluorobutene, wherein the tetrafluoropropene is tetrafluoropropene is 2,3,3,3-tetrafluoropropene or E-1,3,3,3-tetrafluoropropene or a combination of 2,3,3,3-tetrafluoropropene and E-1,3,3,3-tetrafluoropropene and the hexafluorobutene is E-1,1,1,4,4,4-hexafluoro-2-butene or Z-1,1,1,4,4,4-hexafluoro-2-butene or a combination of E-1,1,1,4,4,4-hexafluoro-2-butene and Z-1,1,1,4,4,4-hexafluoro-2-butene, wherein the tetrafluoropropene and hexafluorobutene comprise from 90 wt % up to 100 wt % of the fluoroolefin composition.

2. The fluoroolefin composition of claim 1 wherein the tetrafluoropropene is 2,3,3,3-tetrafluoropropene.

3. The fluoroolefin composition of claim 1 wherein the tetrafluoropropene is E-1,3,3,3-tetrafluoropropene.

4. The fluoroolefin composition of claim 1 wherein the tetrafluoropropene is a combination of 2,3,3,3-tetrafluoropropene and E-1,3,3,3-tetrafluoropropene.

5. The fluoroolefin composition of claim 1.

6. The fluoroolefin composition of claim 1, wherein the hexafluorobutene is Z-1,1,1,4,4,4-hexafluorobutene.

7. The fluoroolefin composition of claim 1, wherein the hexafluorobutene is a combination of both of E-1,1,1,4,4,4-hexafluoro-2-butene and Z-1,1,1,4,4,4-hexafluoro-2-butene.

8-22. (canceled)

23. The fluoroolefin composition of claim 1, wherein the composition comprises one or more additional compounds chosen from CC-40 (chloromethane), CFC-12 (dichlorodifluoromethane), HFC-23 (trifluoromethane), HCFC-124 (1-chloro-1,2,2,2 tetrafluoroethane), HCFC-124a (1-chloro-1,1,2,2-tetrafluoroethane), HCFC-142b (1-chloro-1,1-difluoroethane), HFC-143a (1,1,1-trifluoroethane), HFC-244bb (2-chloro-1,1,1,2-tetrafluoropropane), HFC-245cb (1,1,1,2,2-pentafluoropropane), HFC-245fa (1,1,1,3,3-pentafluoropropane), HFC-254eb (1,1,1,2-tetrafluoropropane), HFC-263fb (1,1,1-trifluoropropane), HFO-1123 (1,1,2-trifluoroethylene), HFO-1243zf (3,3,3-trifluoropropene), HFO-1225ye (E- or Z-1,2,3,3,3-pentafluoropropene), HFO-1225zc (1,1,3,3,3-pentafluoropropene), 3,3,3-trifluoro-1-propyne, HCFO-1233xf (2-chloro-3,3,3-trifluoropropene), HCFO-1122 (2-chloro-1,1-difluoroethylene), HFO-1132 (E- and/or Z-1,2-difluoroethylene), HCFO-1132a (1,1-difluoroethylene), HCO-1140 (vinyl chloride), HCFO-1131 (E- and/or Z-1-chloro-2-fluoroethylene), and HCFO-1131a (1-chloro-1-fluoroethylene), wherein the amount of the one or more additional compound is greater than 0 wt % and less than 1 wt %.

24-29. (canceled)

30. The fluoroolefin composition of claim 23, wherein the additional compound is chosen from one or more of Z-HFO-1225ye, HC-40, E-HFO-1132 and HFC-263fb.

31. The fluoroolefin composition of claim 23, wherein the additional compound is a combination of Z-HFO-1225ye, E-HFO-1132 and HFC-263fb.

32. (canceled)

33. The fluoroolefin composition of claim 23 wherein the amount of the one or more additional compound is greater than 0.1 ppm and less than 0.5 wt % of the total weight of the composition.

34. The fluoroolefin composition of claim 23 wherein the amount of the one or more additional compound is greater than 1 ppm and less than 0.1 wt % of the total weight of the composition.

35. The fluoroolefin composition of claim 23 wherein the amount of the one or more additional compound is greater than 10 ppm or greater than 100 ppm or greater than 1000 ppm.

36-44. (canceled)

45. A heat transfer system comprising the fluoroolefin composition of claim 1.

46. The system of claim 45 wherein the heat transfer system is a stationary system chosen from a refrigeration, air-conditioning or heat pump apparatus.

47. The heat transfer system of claim 45, wherein the heat transfer system is a mobile system which is a mobile air-conditioning system.

48. The composition of claim 1 further comprising a lubricant.
